(19) United States
(12) Patent Application Publication
(10) Pub. No.: US 2021/0222726 A1
(43) Pub. Date: Jul. 22, 2021

(54) LOCKING NUT ASSEMBLY

(71) Applicants: Jack LIN, Taipei City (TW); CHAI-WEI LIN, Taipei City (TW)

(72) Inventors: Jack LIN, Taipei City (TW); CHAI-WEI LIN, Taipei City (TW)

(21) Appl. No.: 17/153,932

(22) Filed: Jan. 21, 2021

(30) Foreign Application Priority Data
Jan. 22, 2020 (TW) 109102624

(51) Int. Cl. F16B 39/284

(52) U.S. Cl. CPC F16B 39/284

(57) ABSTRACT

A locking nut includes a first nut, including a nut base and a screwing portion protruding outward from a face of the nut base, where the screwing portion is provided with a plurality of longitudinal sectional grooves in a spaced manner, such that the screwing portion is formed with a plurality of screwing claw bodies, and a first inner threaded wall is provided on each of inner walls of the screwing claw bodies, and is used for threadedly connecting to a bolt; and a pressing ring, mounted and located outside the screwing portion of the first nut, where an inner wall of the pressing ring includes a pressing inner-wall for pressing outer walls of the screwing claw bodies of the screwing portion.

### BACKGROUND OF THE INVENTION

### Field of Invention

The present invention relates to a nut, and in particular, to a locking nut assembly.

### Description of Related Art

Screwing between a nut and a bolt is used for locking an object. That is, after a bolt is passed through one or more objects, a nut is threadedly connected to an end portion of the bolt, for locking the objects.

However, factors, such as shakes, may sometimes cause disengagement between a nut and a bolt, further resulting in thread-off or loosening of a locked object.

In view of this, a locking nut is designed, to prevent disengagement between the nut and a bolt.

Referring to FIG. 1 and FIG. 2, FIG. 1 and FIG. 2 show an exploded view and a sectional view of assembly of a conventional lock nut assembly. As shown in the figures, a conventional locking nut assembly includes an eccentric nut 400 and a locking nut 500. The eccentric nut 400 is provided with an eccentric screw hole 410. That is, a wall body on a periphery of the eccentric screw hole 410 includes a thin wall 411 and a thick wall 412 that are opposite to each other. The eccentric screw hole 410 is used for threadedly connecting to a bolt 300. The locking nut 500 is mounted outside the wall body of the eccentric screw hole 410 of the eccentric nut 400, is locked to the bolt 300 by means of a locking screw hole 510 thereof, and meanwhile, presses the thick wall 412 of the eccentric nut 400 by means of an inner wall 520 of the locking nut 500, to prevent disengagement of the eccentric nut 400.

However, such a conventional locking nut assembly with an eccentric design has the following disadvantages in use: (1) pressing points thereof are on single side, resulting in a risk of a tooth collapse and poor shock resistance; and (2) because the pressing points thereof appear between the locking nut 500 and the eccentric nut 400, and pressing forces thereof cannot be transmitted to between the eccentric nut 400 and the bolt 300, locking forces applied to the bolt 300 cannot be increased accordingly, resulting in poor lockability thereof.

### SUMMARY

The present invention provides a locking nut assembly having good shock resistance and lockability.

According to an aspect of the present invention, a locking nut is provided, including a first nut, including a nut base and a screwing portion protruding outward from a face of the nut base, where the screwing portion is provided with a plurality of longitudinal sectional grooves in a spaced manner, such that the screwing portion is formed with a plurality of screwing claw bodies, and a first inner threaded wall is provided on each of inner walls of the screwing claw bodies, and is used for threadedly connecting to a bolt; and a pressing ring, mounted and located outside the screwing portion of the first nut, where an inner wall of the pressing ring includes a pressing inner-wall for pressing outer walls of the screwing claw bodies of the screwing portion.

According to an embodiment of the present invention, an outer wall of the screwing portion of the first nut is a tapered outer wall, and the pressing inner-wall of the pressing ring is a tapered pressing inner-wall matching the tapered outer wall.

According to an embodiment of the present invention, the outer walls of the screwing claw bodies of the screwing portion of the first nut are formed with symmetrical outward-protruding deformations.

According to an embodiment of the present invention, the pressing ring is a second nut, an inner wall of the second nut includes the pressing inner-wall and a second inner threaded wall, and the second inner threaded wall is used for threadedly connecting to the bolt.

According to an embodiment of the present invention, the pressing ring is a washer, and an inner wall of the washer includes the pressing inner-wall.

According to the locking nut assembly of the present invention, the plurality of screwing claw bodies of the screwing portion of the first nut and the symmetrical outward-protruding deformations of the outer walls thereof are designed to enable the locking nut assembly to have good shock resistance and lockability.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

In order to make the above and other objects, features and advantages of the disclosure more comprehensible, several embodiments accompanied with figures are described in detail below.

FIG. 1 shows an exploded view of a conventional eccentric locking nut assembly.

FIG. 2 shows a sectional view of assembly of the eccentric locking nut assembly shown in FIG. 1.

FIG. 3 shows an exploded view of a locking nut assembly according to a first embodiment of the present invention.

FIG. 4 shows an appearance diagram of assembly of the locking nut assembly shown in FIG. 3.

FIG. 5 shows a sectional view of a cross section of assembly of the locking nut assembly shown in FIG. 3.

FIG. 6 shows a sectional view of a longitudinal section of assembly of the locking nut assembly shown in FIG. 3.

FIG. 7 shows an enlarged diagram of a portion A in the locking nut assembly shown in FIG. 6.

FIG. 8 shows a sectional view of a longitudinal section of assembly of a locking nut assembly according to a second embodiment of the present invention.

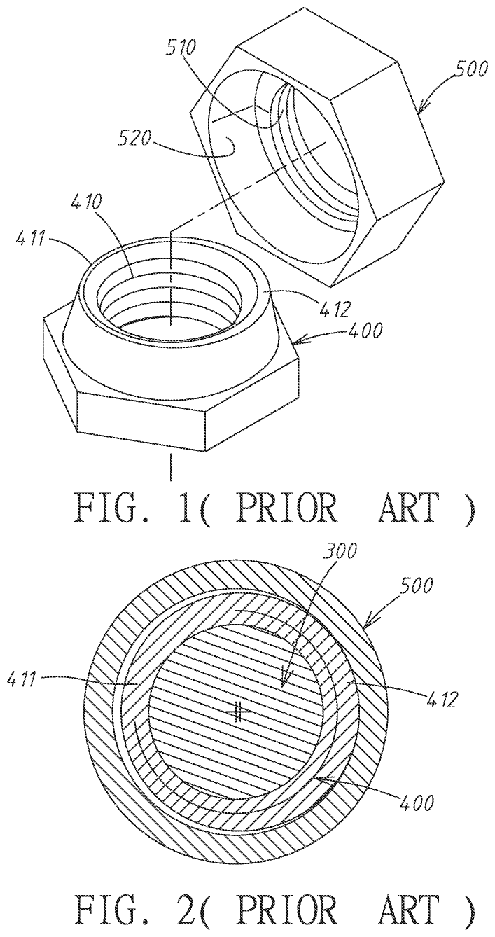

### DETAILED DESCRIPTION

Reference will now be made in detail to the present preferred embodiments of the disclosure, examples of which are illustrated in the accompanying drawings. Wherever possible, the same reference numbers are used in the drawings and the description to refer to the same or like parts.

To comprehensively describe the disclosure in detail, reference may be made to the accompanying drawings and various embodiments. Meanwhile, components and steps known by the public are not described in the embodiments to prevent unnecessary limitations from being imposed to the disclosure.

Terms such as “couple” or “connect” used in the embodiments may refer to two or more components being in physical or electrical contact with each other “directly”, two or more components being in physical or electrical contact with each other “indirectly”, or acting of two or more components with each other.

The foregoing and other technical content, features, and effects of the present invention can be clearly presented below in detailed descriptions of embodiments with reference to the drawings.

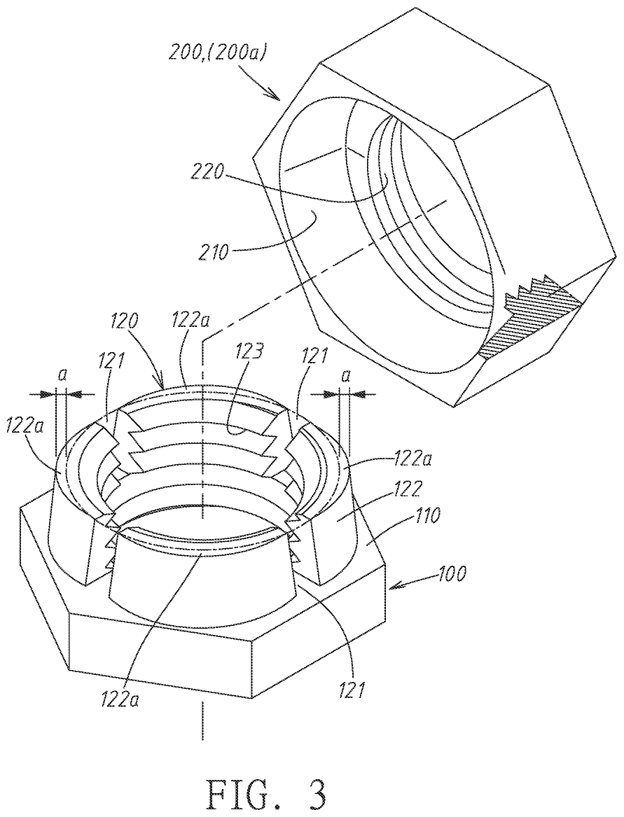

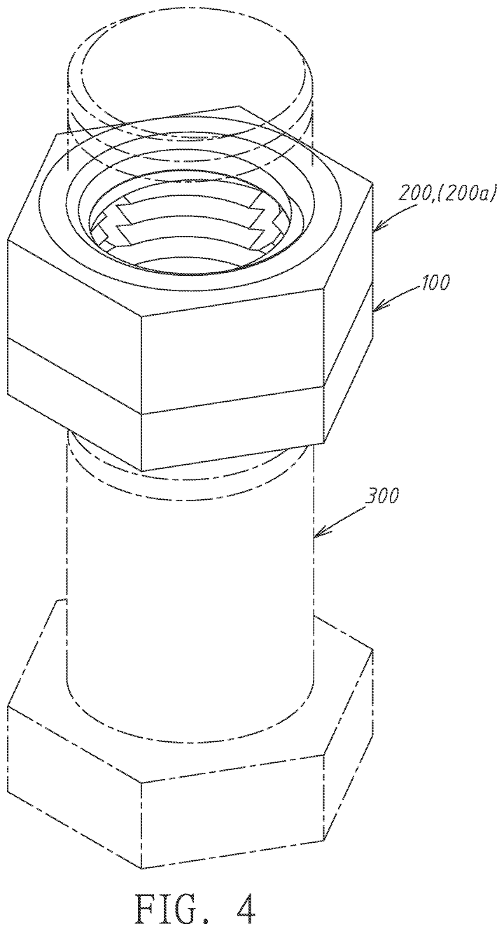

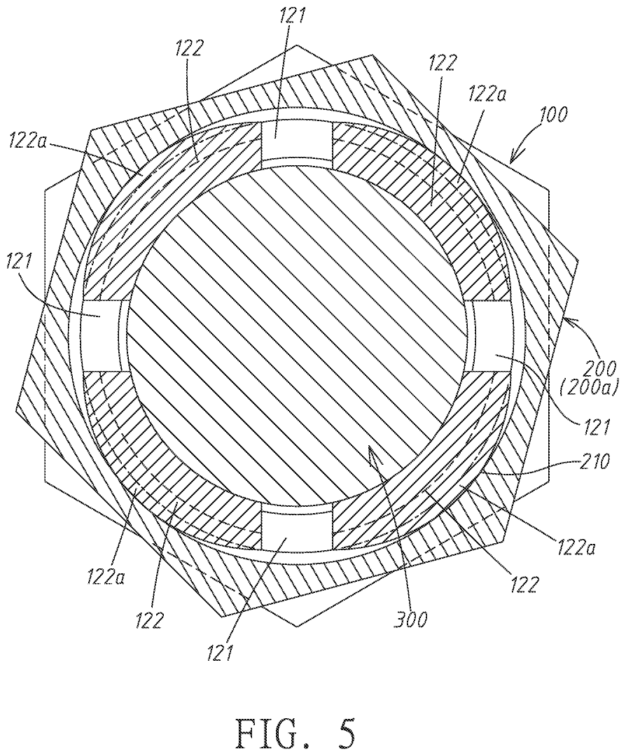

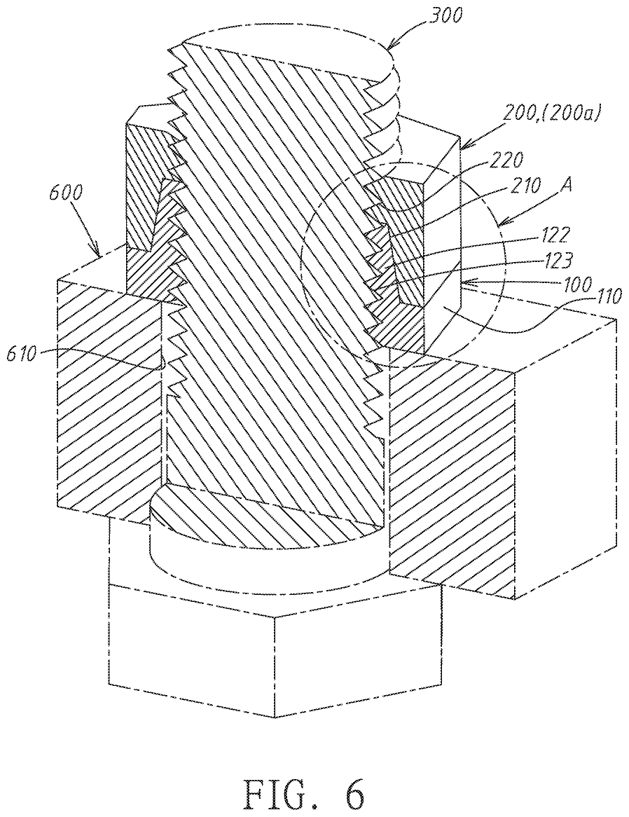

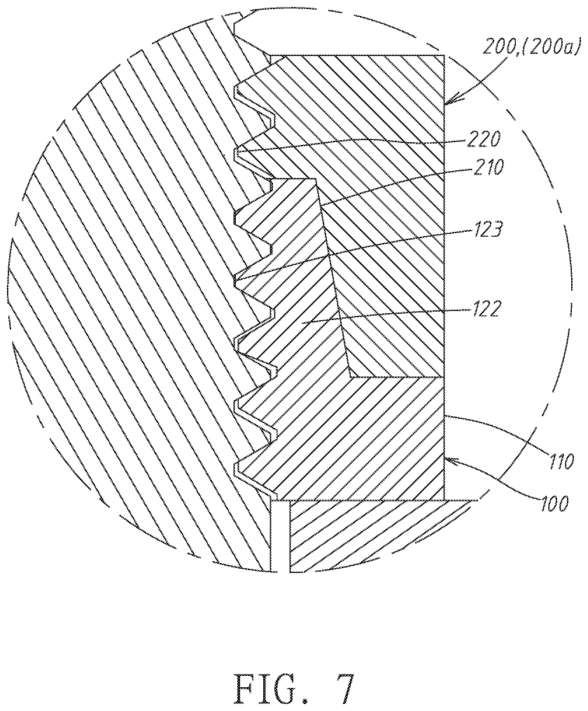

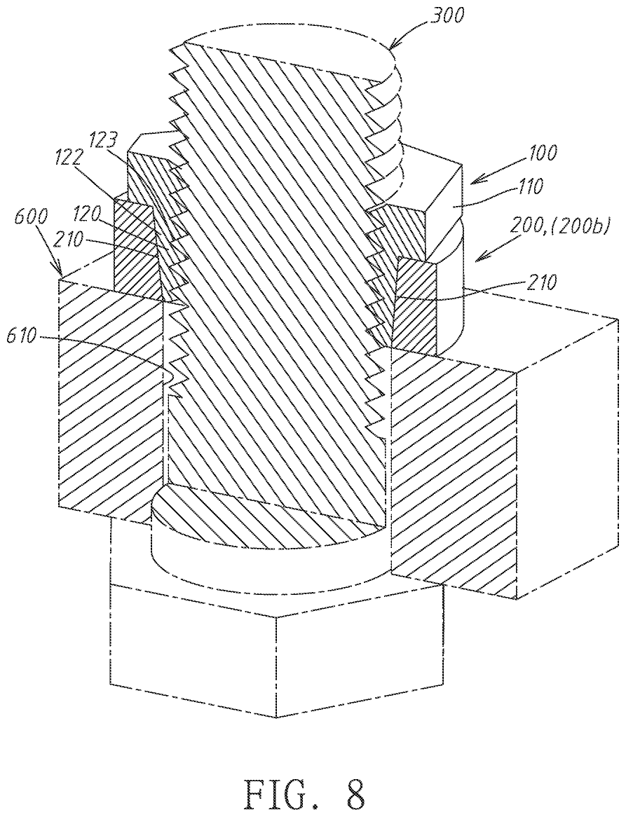

Referring to FIG. 3 to FIG. 7, a locking nut assembly according to a first embodiment of the present invention includes a first nut 100 and a pressing ring 200. In the first embodiment, the pressing ring 200 is a second nut 200a.

The first nut 100 includes a nut base 110 and a screwing portion 120 protruding outward from a face of the nut base. An outer wall of the screwing portion 120 is a tapered outer wall. In addition, the screwing portion 120 is provided with a plurality of (four, as shown in the figure of the embodiment in the accompanying drawings) longitudinal sectional grooves 121, such that parts between adjacent longitudinal sectional grooves 121 of the screwing portion 120 are formed with a plurality of (four, as shown in the figure of the embodiment in the accompanying drawings) screwing claw bodies 122. In addition, outer walls of the screwing claw bodies 122 are formed with symmetrical outward-protruding deformations 122a, where a dimension of the protruding deformation is “a” (for example, “a” is equal to 1 mm). A first inner threaded wall 123 is provided on each of inner walls of the screwing claw bodies 122, and is used for threadedly connecting to a bolt 300.

The pressing ring 200 (second nut 200a) is mounted and located outside the screwing portion 120 of the first nut 100. An inner wall of the second nut 200a includes a pressing inner-wall 210 and a second inner threaded wall 220. The pressing inner-wall 210 is formed as a tapered pressing inner-wall matching the tapered outer wall of the first nut 100, and is used for pressing against the outer walls of the screwing claw bodies 122 of the screwing portion 120 of the first nut 100. The second inner threaded wall 220 is used for threadedly connecting to the bolt 300.

In use, after the bolt 300 is passed through a locking hole 610 provided in at least one object 600, the first nut 100 is threadedly connected to an end portion of the bolt 300 by means of the first inner threaded wall 123 thereof, and further, the second nut 200a is threadedly connected to the end portion of the bolt 300 by means of the second inner threaded wall 220 thereof, and meanwhile, the screwing claw bodies 122 of the first nut 100 are pressed inward by the pressing inner-wall 210 of the second nut 200a, thereby locking the object 600.

Because the outer walls of the screwing claw bodies 122 of the first nut 100 are formed with the symmetrical outward-protruding deformations 122a, when the second nut 200a is threadedly connected to the bolt 300 and is mounted outside the screwing portion 120 of the first nut 100, a plurality of pressing points are naturally formed between positions of the outward-protruding deformations 122a of the screwing claw bodies 122 of the screwing portion 120 and the pressing inner-wall 210 of the second nut 200a. In addition, the pressing points are evenly distributed on a periphery of the screwing portion 120 and are subject to forces evenly, so that the locking nut assembly has good shock resistance and a good locking effect. Furthermore, pressing forces applied by the second nut 200a to the screwing claw bodies 122 of the screwing portion 120 of the first nut 100 are transmitted to between the first inner threaded wall 123 of the first nut 100 and the bolt 300, thereby increasing locking forces applied by the first nut 100 to the bolt 300, which has good lockability.

Referring to FIG. 8, FIG. 8 shows a sectional view of a longitudinal section of assembly of a locking nut assembly according to a second embodiment of the present invention. A structure of the first nut 100 is completely the same as that shown in the first embodiment, but the pressing ring 200 is a washer 200b, and an inner wall of the washer includes the pressing inner-wall 210.

In use, after the bolt 300 is passed through a locking hole 610 provided in at least one object 600, the screwing portion 120 of the first nut 100, after being passed through and accommodated in the pressing inner-wall 210 of the washer 200b, is threadedly connected to the end portion of the bolt 300 by means of the first inner threaded wall 123 of the first nut 100. In this case, the first nut 100 presses and fixes the washer 200b to a surface of the object 600 by means of the nut base 110 thereof, and meanwhile, with the continuous screwing of the first nut 100, the screwing claw bodies 122 of the first nut 100 are pressed inward by the pressing inner-wall 210 of the washer 200b, thereby locking the object 600.

Because the outer walls of the screwing claw bodies 122 of the first nut 100 are formed with symmetrical outward-protruding deformations 122a (referring to FIG. 3), during a screwing operation of the first nut 100, a plurality of pressing points are naturally formed between positions of the outward-protruding deformations 122a of the screwing claw bodies 122 of the screwing portion 120 of the first nut 100 and the pressing inner-wall 210 of the washer 200b. In addition, the pressing points are evenly distributed on a periphery of the screwing portion 120 and are subject to forces evenly, so that the locking nut assembly has good shock resistance and a good locking effect. Furthermore, pressing forces applied by the washer 200b to the screwing claw bodies 122 of the screwing portion 120 of the first nut 100 are transmitted to between the first inner threaded wall 123 of the first nut 100 and the bolt 300, thereby increasing locking forces applied by the first nut 100 to the bolt 300, leading to good lockability thereof.

According to the locking nut assembly of the present invention, the plurality of screwing claw bodies of the screwing portion of the first nut and the symmetrical outward-protruding deformations of the outer walls thereof are designed to enable the locking nut assembly to have good shock resistance and lockability.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A locking nut assembly, for threadedly connecting to a bolt, the locking nut assembly comprising:
a first nut, comprising a nut base and a screwing portion protruding outward from a face of the nut base, wherein the screwing portion is provided with a plurality of longitudinal sectional grooves in a spaced manner, such that the screwing portion is formed with a plurality of screwing claw bodies, a first inner threaded wall is provided on each of inner walls of the screwing claw bodies, and is used for threadedly connecting to a bolt, and outer walls of the screwing claw bodies are formed with symmetrical outward-protruding deformations; and
a pressing ring, mounted and located outside the screwing portion of the first nut, wherein an inner wall of the pressing ring comprises a pressing inner-wall for pressing the outer walls of the screwing claw bodies of the screwing portion.

2. The locking nut assembly according to claim 1, wherein an outer wall of the screwing portion of the first nut is a tapered outer wall, and the pressing inner-wall of the pressing ring is a tapered pressing inner-wall matching the tapered outer wall.

3. The locking nut assembly according to claim 1, wherein the pressing ring is a second nut, an inner wall of the second nut comprises the pressing inner-wall and a second inner threaded wall, and the second inner threaded wall is used for threadedly connecting to the bolt.

4. The locking nut assembly according to claim 1, wherein the pressing ring is a washer, and an inner wall of the washer comprises the pressing inner-wall.
